(19) United States
(12) Patent Application Publication
(10) Pub. No.: US 2005/0161286 A1
(43) Pub. Date: Jul. 28, 2005

(54) Rescue system for high-rise buildings

(76) Inventor: Eliyahu Nir, Pardesiya (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/493,159

(22) PCT Filed: Oct. 8, 2002
(86) PCT No.: PCT/IL02/00815

(30) Foreign Application Priority Data
Oct. 15, 2001 (IL) 145935

(51) Int. Cl. A62B 1/20

(52) U.S. Cl. 182/48

(57) ABSTRACT

A system for the evacuation of individuals trapped in multiple-story buildings (10) by gliding down a rescue sleeve (14), comprising a first helical sleeve supporting spring (20) of a first diameter, spiraling from an elevated level of the building (10) down to a lower level thereof. A second helical sleeve supporting spring (22) is provided being of a second, smaller diameter, spiraling from the elevated location down to the lower level. The second spring (22) extends within, concentrical with respect to and having the same pitch as that of the first spring (20). A sleeve (24) made of sheet material is positioned between the first and second sleeve supporting springs, attached thereto by series of distanced rigid rings (32) slideably coupled to both the first and the second springs. According to a modified version only one helical sleeve supporting spring is employed.

### BACKGROUND OF THE INVENTION

The present invention relates to rescue systems for evacuating individuals trapped in high rise buildings in case of emergency situations such as fire or earthquake.

The invention particularly concerns rescue systems of the kind disclosed in the inventor's International Patent Application, published Aug. 30, 2001, as WO01/62138 (herein referred to “the WO Patent”).

As described and claimed in the WO Patent, a system is provided for the evacuation of individuals trapped in multiple story buildings by gliding down a rescue sleeve. The sleeve is composed of sections, each section being made of a sheet material strengthened by a circumferential rigid support member, and the sections connect to each other to form a continuous envelope. At least a pair of cables are provided, threaded along the sleeve, one at the bottom and one at the top generatrix thereof. A pair of winch systems are provided for winding the cables into a dedicated location at the building story from where rescue is to be initiated, so that the sleeve becomes folded into a compact package. Coil springs are used for selectively ejecting and unfolding the sleeve down to ground level where it is anchored to a stationary object.

Thus, the rescue sleeve of the WO Patent is designed to unfold and deploy in an inclined direction, from the evacuation point down to the ground level. This feature presents a certain disadvantage in that the anchoring point for the lower end of the sleeve has to be located at a distance from building, depending on the height of the story designated as the evacuation point. This operational pre-requisite may not always be possible to satisfy, depending on the urban surrounding of the building in question.

Therefore, the main object of the present invention is to overcome this deficiency while still maintaining the basic principles of the WO Patent rescue sleeve.

It is a further object of the invention to provide a rescue sleeve that will be deployed vertically, however in a spiral configuration.

It is a still further object of the invention that the rescue sleeve be stored (and restored after use) within a designated compartment situated at the respective story of the building in a readily operable position should an emergency situation occur.

### SUMMARY OF THE INVENTION

Thus provided, according to one aspect of the present invention is a rescue system for the evacuation of individuals trapped in multiple-story buildings by gliding down a rescue sleeve, the system comprising: A first helical sleeve supporting member made of an elastically deformable material, of a first diameter spiraling from an elevated level of the building down to a lower level thereof; a second helical sleeve supporting member made of an elastically deformable material, of a second, smaller diameter spiraling from the elevated location down to the lower level, extending within, concentrical with respect to and having the same pitch as that of the first sleeve supporting member; a sleeve made of sheet material having a diameter substantially equal to the distance defined between the first and second sleeve supporting members; a series of distanced rigid rings attached to and embracing the sleeve in parallel to each other; and means for slideably coupling each of the rings at two, fixed horizontally opposite diametrical points thereof to both the first and the second helical sleeve supporting members.

According to another aspect of the invention there is provided a rescue system for the evacuation of individuals trapped in multiple-story buildings by gliding down a rescue sleeve, the system comprising: A helical sleeve supporting member made of an elastically deformable material, spiraling from an elevated level of the building down to a lower level thereof; a sleeve made of sheet material; a series of distanced rigid rings attached to and embracing the sleeve in parallel to each other; and means for slideably coupling each of the rings to the sleeve supporting member.

### BRIEF DESCRIPTION OF THE DRAWINGS

These and further constructional features and advantages of the invention will be more clearly understood in the light of the ensuing description of two preferred embodiments thereof, given by way of example only, with reference to the accompanying drawings, wherein—

FIG. 1 is a general schematic view of a building provided with the rescue system designed according to the principles of the present invention;

FIG. 2 illustrates the two helical sleeve supporting members in their fully deployed positions;

FIGS. 3a and 3b show the rescue sleeve In partly and fully deployed positions, respectively;

FIG. 4 shows how the sleeve embracing rings are coupled to the outer and the inner helical sleeve supporting members;

FIG. 5 is a cross sectional view showing the rescue system in its standby position within the storage compartment;

FIG. 6 is a view taken along lines VI-VI of FIG. 5;

FIG. 7 illustrates the stage of deploying the pair of helical sleeve supporting members by being lowered to ground level;

FIG. 8 illustrates the system in its extended, ready-for-use position;

FIG. 9 illustrates another embodiment of the invention, using only a single helical sleeve support member;

FIG. 10 shows the deployment of the rescue sleeve supported on the support member of FIG. 9; and,

FIG. 11 shows how the sleeve embracing rings are coupled to the single helical sleeve supporting member of FIGS. 9 and 10.

### DETAILED DESCRIPTION OF PREFERRED EMBODIMENTS

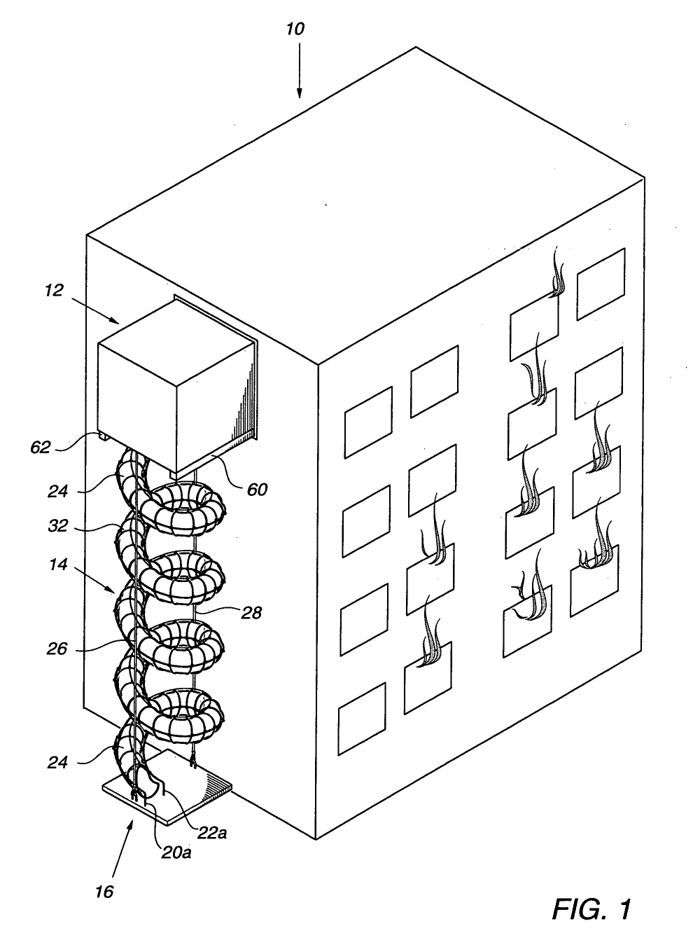

FIG. 1 illustrates a building 10 in flames or other disaster situation of similar nature, namely needing fast mass evacuation.

A rescue system storage compartment 12 has been ejected from one of the elevated stories of the building (see more details below) and a rescue sleeve assembly 14 has been deployed by lowering a base plate 16 down to ground level.

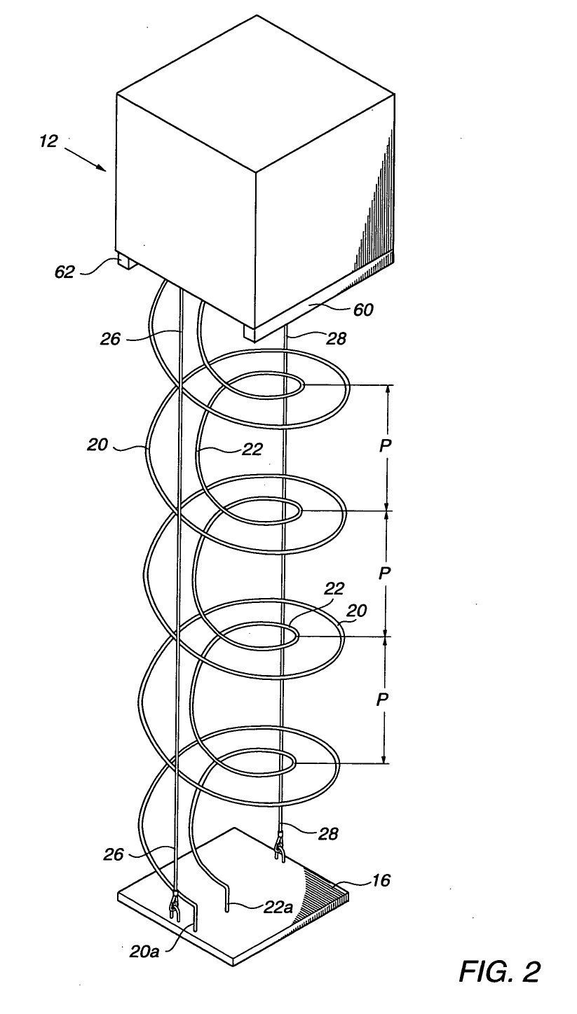

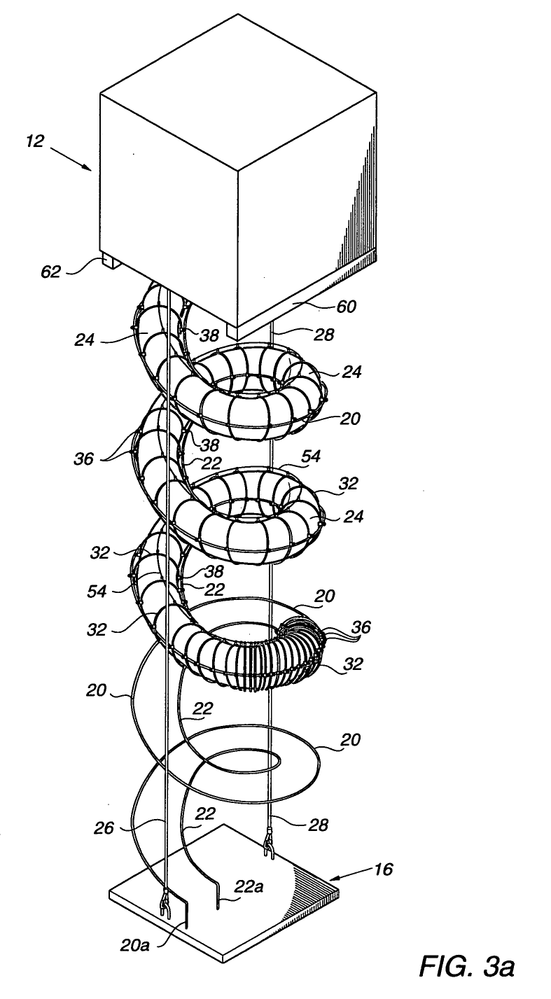

As more clearly seen in FIGS. 2 and 3, the sleeve assembly 14 is comprised of two main components:
1) A pair of helical sleeve supporting members 20 and 22 (hereinafter called “the springs”), one within the other, spiraling down in co-axial relationship. Respective convolutions of the two springs are spaced from each other all along (seen in horizontal planes) by the same pitch P; and
(2) A rescue sleeve 24 of a diameter conforming the horizontal distance between the outer and the inner springs 20, 22, being large enough to allow a person to comfortably lie inside and slide down, as shown in phantom lines at the bottom of FIG. 3b.

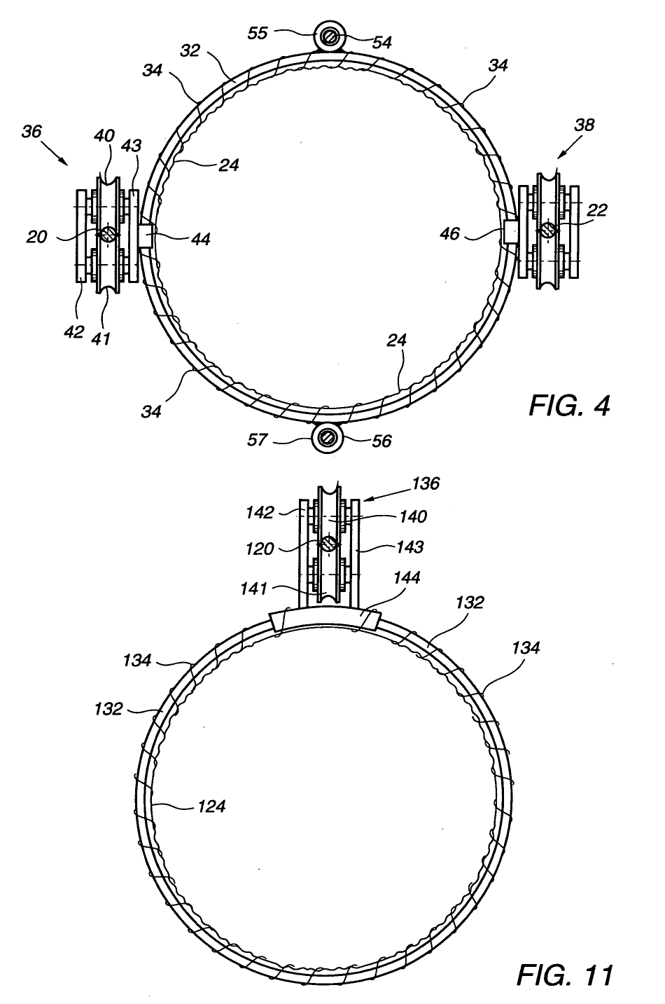

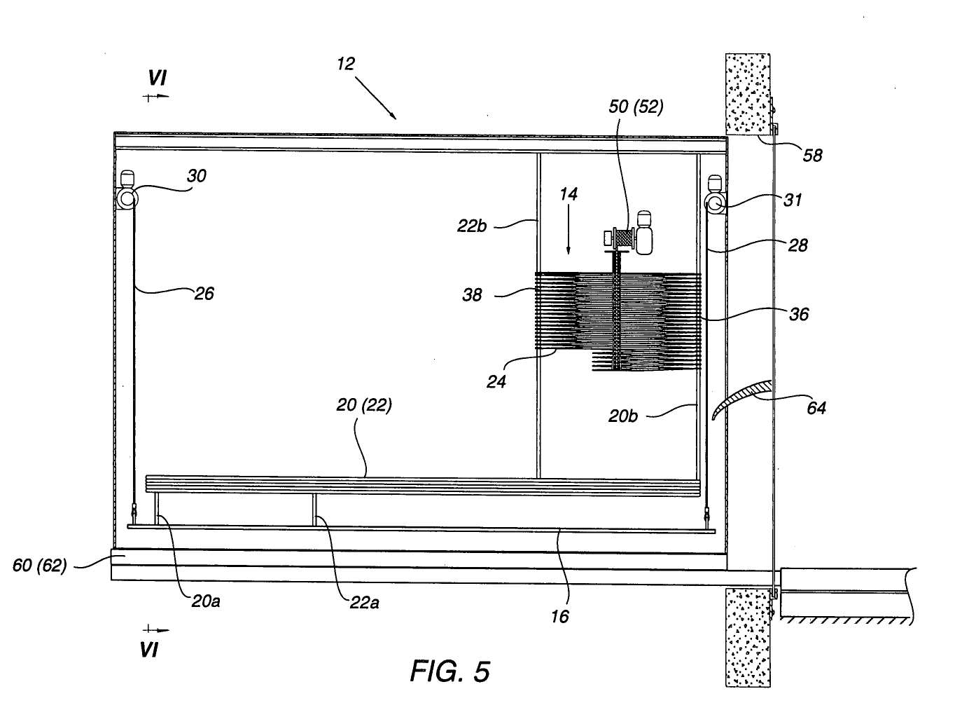

Now in more detail, the outer and inner springs are preferably made of springy steel wire (circular, square or of other suitable cross-section) for providing, on the one hand the ability to stretch from a compact position (see below in conjunction with FIGS. 5 and 6) to the operative, sleeve bearing position; and, on the other hand, to present enough mechanical strength so as not to yield under the weight of the sliding persons. The bottom ends of the springs 20 and 22 terminate each by upright, straight leg-like sections 20a and 22a through which they are affixed to the base plate 16. The base plate 16 may be used as the floor of the compartment 12, and should be of a weight sufficient to cause the deformation of the springs to their designated stretched length, namely down to the ground level or any intermediate level, for example, a certain number of stories below the evacuation story where the storage compartment 12 is installed.

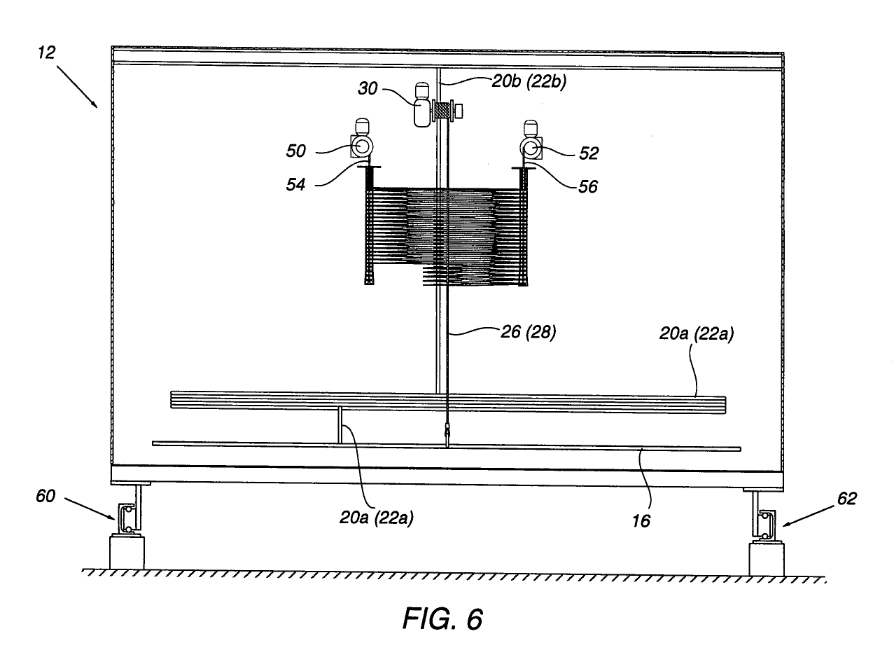

At the uppermost ends, the springs are formed again as straight sections 20b and 22b by which they are affixed to the ceiling of the storage compartment 12 (see below). Hence, the springs system can be stretched to the lowered operative position (FIG. 7) by lowering the base plate 16. This is accomplished by a pair (or more) of cables 26 and 28 coupled respectively to winch motors 30 and 31. By winding the cables 26 and 28, the springs 20 and 22 can be brought into the compact, standby configuration (see FIGS. 6 and 7).

Sleeve 24 can be made of canvas or any other suitable sheet material, preferably fireproof.

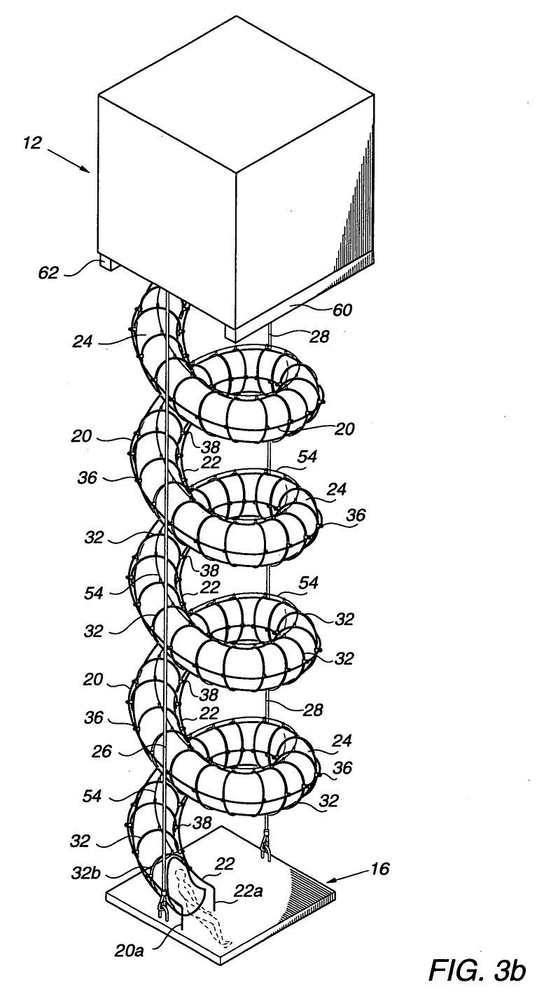

The sleeve 24 is reinforced by a series of reinforcing rings 32, of metal or plastics—one being shown in FIG. 4—affixed to the sleeve by stitches 34 or in any other suitable manner.

A preferred arrangement for coupling the rings 32 to the outer spring 20 at one (left) side, and to the inner spring 22 at the other (right) side, is depicted in FIG. 4.

Hence, there are provided a pair of coupling units generally denoted 36 and 38, respectively. The unit comprises a pair of freely rotatable rollers 40 and 41 both having a concave circumference so that the spring 20 fits therebetween. The rollers are mounted between plates 42 and 43 the latter being pivotally mounted to the 9 o'clock point of the respective ring 32, as by joint 44.

The structure of the coupling unit 38, provided at the 3 o'clock point is the same and need therefore need not be described in detail.

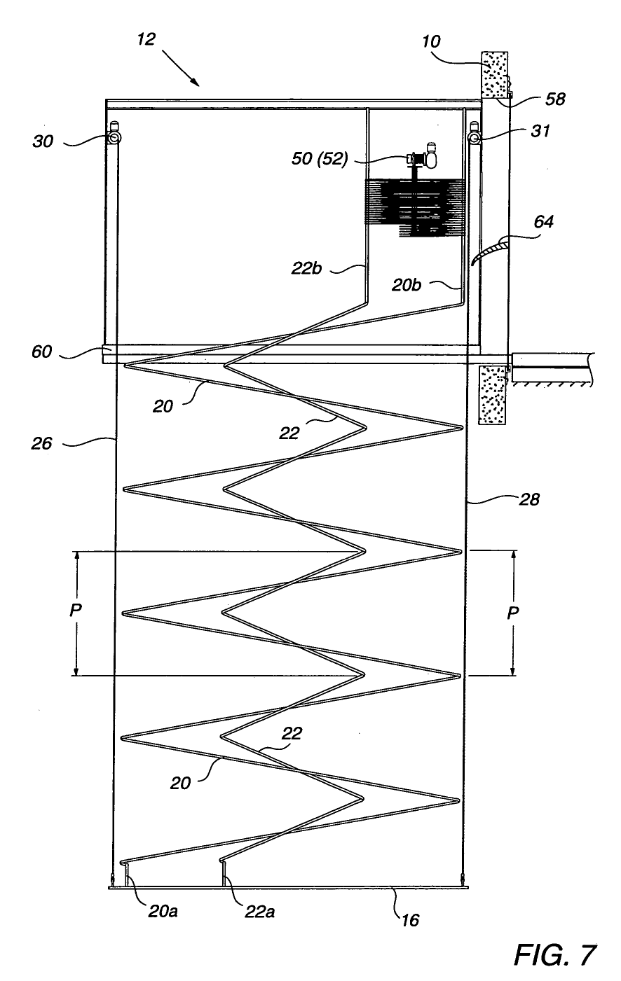

In FIGS. 5-7, the sleeve assembly 14 is shown in the folded-back, standby position. To enable the lifting of the sleeve to this storing position, it is proposed according to a further feature of the present invention, to provide a pair of winch motors 50, 52 adapted to pay/wind wires 54, 56 which are loosely attached, e.g. by eyelets 55 and 57 (FIG. 4), to all rings 32 at the 12 o'clock and the 6 o'clock points, respectively, except for the last-in-line ring that Is located at the bottom of the sleeve denoted 32b (as seen in FIG. 3b and FIG. 8), to which the wires are firmly tied. This arrangement will enable the gradual downward unfolding of the sleeve and the subsequent refolding after use.

Obviously, this feature is optional, namely that if the system is designed for one-time use, the operation can be limited to allowing the sleeve to glide down solely by gravity and not to re-use it again, but to replace the system as a whole.

The storage compartment 12 is extractable out of the building 10 through opening 58 (FIG. 8) being supported on drawer-like rails 60, 62—or by any equivalent means.

The operation of the rescue system would now be readily understood. When evacuation is needed, the storage compartment 12 is extracted from the building 10, through the opening 58, gliding on the rails 60 and 62, either manually or by mechanical means.

First, the winch motors 30, 31 are actuated to unwind the cables 26 and 28. The weight of the base plate 16 initiates the stretching of the springs 20 and 22 from their compact state (FIG. 5). When the base plate arrives at the designated position (ground level or any intermediate level), achieving the position of FIG. 2, the unfolding of the sleeve 24 is initiated—as shown in FIGS. 3a and 3b. This is achieved by the winch motors 50 and 52, unwinding the wires 54 and 56 which are tied to the bottom ring 32b. and only freely threaded to all the rings thereabove. The system is now ready for use. As schematically shown in FIG. 8, a person is about to let himself off a consol 64 and into the sleeve 24 through which he will spiral downward (FIG. 3b); so will others, at properly timed intervals.

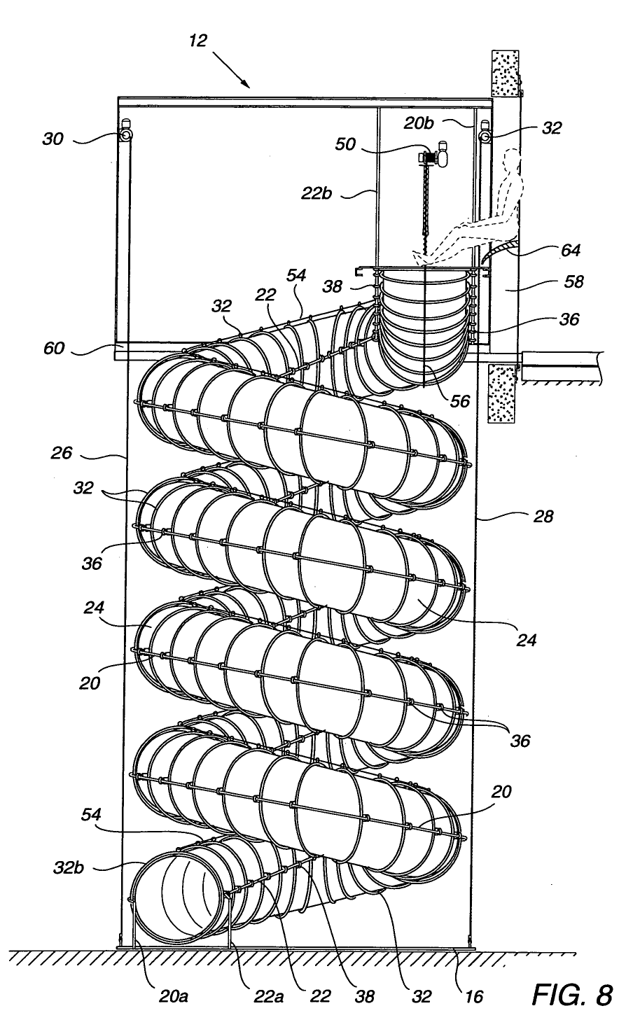

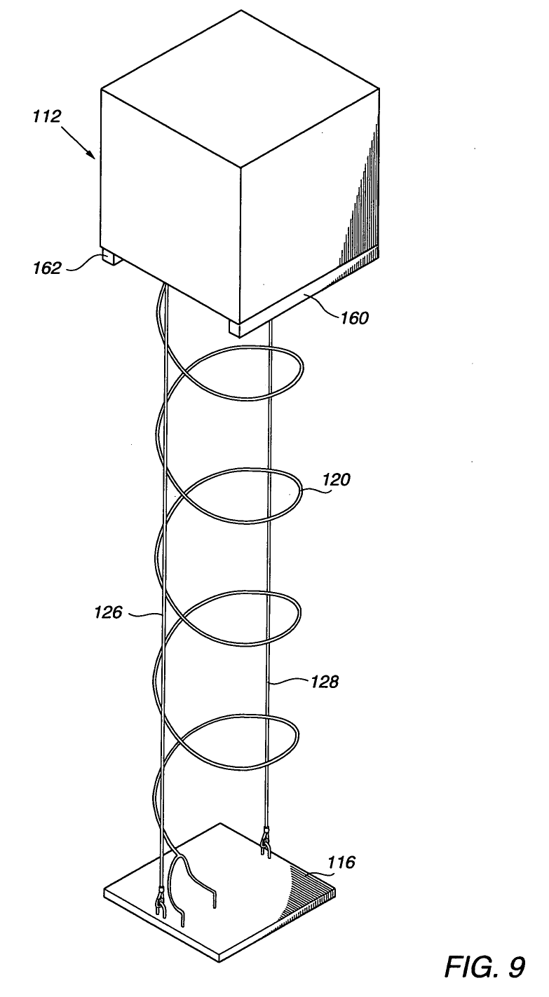

According to a modified embodiment illustrated in FIGS. 9-11, use is made of only a single helical rescue sleeve support member (“spring”) denoted 120. Lowering the base plate 116 by cables 126, 128 will cause the stretching of the spring 120 along the building wall as in the preceding embodiment.

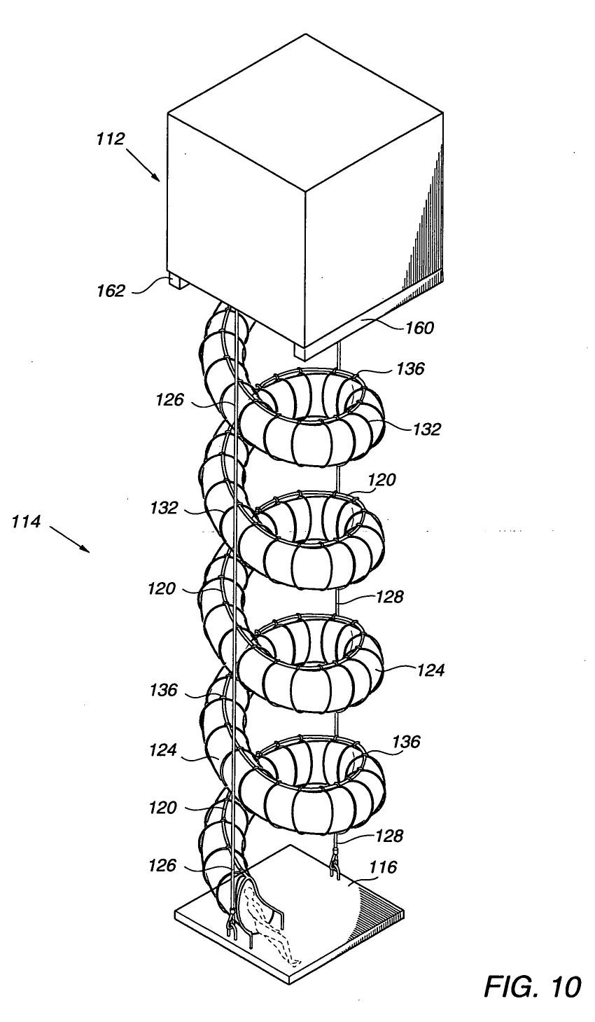

The manner of harnessing the sleeve 124 via reinforcing rings 132 to the spring 120 differs, however, in that only one support point is available at the 12 o'clock position as seen in FIG. 11. Therefore, only one coupling unit 136 is provided slidingly fitting over the spring 120 whereby the unfolding of the sleeve 124 is enabled by gravity once released from its storage position within the compartment 112 (not shown).

No means for collecting the sleeve back into the stored position are exemplified, it being understood that these may be analogous to those described in conjunction with the preceding embodiment.

It will be readily understood that, apart from certain similarities, the rescue system herein proposed ingeniously introduces an important advantage over the inclined sleeve concept represented by the WO Patent: The application of the system depends no longer on the availability of a remotely located anchor, and the entailing preparatory stages of suspending of at least one cable between the evacuation point and the anchor are dispensed with; if preferred, this very feature will enable survivors to descend from a higher story to a lower one in a fraction of the time required for the full descent from an upper story to ground level, as dictated by the WO Patent system.

Those skilled in the art will readily appreciate that numerous changes, variations, and modifications may be applied to the invention as heretofore exemplified and the scope thereof may therefore be defined only in and by the appended claims.

1. A system for the evacuation of individuals trapped in multiple-story buildings (10) by gliding down a rescue sleeve (14), the system comprising:
a first helical sleeve supporting member (20) made of an elastically deformable material, of a first diameter, spiraling from an elevated level of the building (10) down to a lower level thereof;
a second helical sleeve supporting member (22) made of an elastically deformable material, of a second, smaller diameter, spiraling from the elevated location down to the lower level, extending within, concentrical with respect to and having the same pitch as that of the first sleeve supporting member (20);
a sleeve (24) made of sheet material having a diameter substantially equal to the distance defined between the first and second sleeve supporting members;
a series of distanced rigid rings (32) attached to and embracing the sleeve; and
means (36) for slideably coupling each of the rings (32) at two, fixed, horizontally opposite diametrical points thereof to both the first and the second helical sleeve supporting members.

2. The system as claimed in claim 1 wherein the first and the second helical sleeve supporting members (20; 22) are made of a springy material.

3. The system as claimed in claim 2 wherein the lower ends (20a; 22a) of the helical sleeve supporting members are connected to a common base plate (16).

4. The system as claimed In claim 2 wherein the upper ends of the helical sleeve supporting members (20; 22) are each formed with an integral upright portion (20b; 22b).

5. The system as claimed in claim 4 further comprising means for collecting the sleeve (24) from the extended position thereof, wherein it convolutes between the helical sleeve supporting members (20; 22) into a folded compact state located between the respective upright portions (20b; 22b).

6. The system as claimed in claim 5 wherein the sleeve collecting means comprise first and second wires (54; 56) tied to the lowermost of said rings (55; 57) at vertically opposite diametrical points, respectively, the wires extending along respective upper and lower generatrixes of the sleeve by being loosely attached to every one of the rings and adapted to be pulled up to the elevated level by first winch means (50; 52).

7. The system as claimed in claim 6 further comprising means for lifting the base plate (16) to the elevated level thereby restoring the first and the second helical sleeve supporting members (20; 22) into a compact state.

8. The system as claimed in claim 7 wherein the base plate (16) is liftable by cables (26; 28) coupled to second winch means (30; 31).

9. The system as claimed in claim 8 comprising a storage compartment (12) for the sleeve (24) and the sleeve supporting members (20; 22) in the compact states thereof, the compartment being normally located within the building at the elevated level thereof, means being provided for extracting the compartment from the building, said base plate (16) forming the bottom wall of the compartment.

10. The system as claimed in claim 9 wherein the compartment is slideable on self-supporting rails (60; 62).

11. A system for the evacuation of individuals trapped in multiple-story buildings by gliding down a rescue sleeve (114), the system comprising:
an elastically helical sleeve supporting member (120) spiraling from an elevated level of the building down to a lower level thereof;
a sleeve (124) made of sheet material;
a series of distanced rigid rings (132) attached to and embracing the sleeve; and
means (136) for slideably coupling each of the rings to the sleeve supporting member.

12. The system as claimed in claim 11 wherein the helical sleeve supporting member is made of a springy material.

13. The system as claimed in claim 12 wherein the lower end of the helical sleeve supporting member is connected to a base plate (116).

14. The system as claimed in claim 13 comprising a storage compartment (112) for the sleeve (124) and the sleeve supporting member (120) in the compact states thereof, the compartment being normally located within the building at the elevated level thereof, means (160; 162) being provided for extracting the compartment from the building, the base plate (116) forming the bottom wall of the compartment (112).

15. The system as claimed in claim 14 wherein the compartment is slideable on self-supporting rails (160; 162).
